(19) United States
(12) Patent Application Publication
(10) Pub. No.: US 2011/0096527 A1
(43) Pub. Date: Apr. 28, 2011

(54) NANOPHOSPHOR, LIGHT EMITTING DEVICE INCLUDING NANOPHOSPHOR, AND METHOD OF PREPARING NANOPHOSPHOR

(75) Inventors: Tae-won JEONG, Yongin-si (KR); Jeong-hee LEE, Seongnam-si (KR); Shang-hyeun PARK, Yongin-si (KR)

(73) Assignee: SAMSUNG ELECTRONICS CO., LTD., Suwon-si (KR)

(21) Appl. No.: 12/887,109

(22) Filed: Sep. 21, 2010

(30) Foreign Application Priority Data
Oct. 26, 2009 (KR) 10-2009-0101732

(51) Int. Cl. F21V 9/16; C01G 9/08; C09K 11/56; B82Y 20/00

(52) U.S. Cl. 362/84; 423/566.1; 252/301.6 S; 977/773; 977/932

(57) ABSTRACT

A nanophosphor including ZnS, having an average particle diameter of about 10 to about 500 nanometers, and having a ZnS cubic (111) peak in an X-ray diffraction spectrum, wherein the ZnS cubic (111) peak has a full width at half maximum (“FWHM”) of about 0.280 degrees or less.

### CROSS-REFERENCE TO RELATED APPLICATIONS

This application claims priority to Korean Patent Application No. 10-2009-0101732, filed on Oct. 26, 2009, and all the benefits accruing therefrom under 35 U.S.C. §119, the content of which in its entirety is herein incorporated by reference.

### BACKGROUND

1. Field

The present disclosure relates to a nanophosphor, a light emitting device including the same, and a method of preparing the nanophosphor.

2. Description of the Related Art

An electroluminescent device is an active solid display device which emits light by electroluminescence in which a material emits light in response to an electric field applied to it. A thin-film-type electroluminescence device has a stacked structure in which a first electrode, a first insulating layer, an emission layer, a second insulating layer, and a second electrode are sequentially stacked on an insulating substrate, and the thin-film-type electroluminescence device emits light in response to an alternating current supplied to the first and second electrodes.

A thin-film-type electroluminescence device has a distinct threshold voltage, and thus may be used as a display device. The thin-film-type electroluminescence device includes a thin film emission layer having a nanometer-scale thickness. If the thickness of the thin film is 1 micrometer (μm) or greater, a driving voltage increases, thereby significantly increasing power consumption. In addition, the thin film is generally prepared by sputtering. The cost of a thin film manufacturing device used to provide the thin film undesirably results in increased manufacturing cost.

In addition, when a nanophosphor is used to form the thin film, the thin film may be easily formed by printing. The nanophosphor may also be used to form a thin film on a flexible substrate.

Nanophosphors are commercially prepared by a chemical or physical method. For example, the chemical method may be a hydrothermal synthesis method. However, when the chemical method is used, it is difficult to mass produce a highly crystalline nanophosphor having a size of equal to or greater than tens of nanometers (nm). The physical method may be pulverization. When the pulverization method is used, the mass production of a nanophosphor is possible, but the nanophosphor prepared by pulverization are amorphous and often defective.

Therefore, there remains a need to develop an improved method of mass producing a nanophosphor that has a highly crystalline structure.

### SUMMARY

Provided is a novel nanophosphor.

Provided is a light emitting device including the nanophosphor.

Provided is a method of preparing the nanophosphor.

Additional aspects will be set forth in part in the description which follows and, in part, will be apparent from the description.

According to an aspect, a nanophosphor includes ZnS, having an average particle diameter of about 10 to about 500 nanometers, and having a ZnS cubic (111) peak in an X-ray diffraction spectrum, wherein the ZnS cubic (111) peak has a full width at half maximum of about 0.280 degrees or less.

According to another aspect, a light emitting device includes the nanophosphor.

According to another aspect, a method of preparing a nanophosphor includes pulverizing a bulk phosphor having an average particle diameter of about 1 micrometer or greater; combining the pulverized bulk phosphor with a chlorine-based inorganic salt to provide a mixture; and heat treating the mixture to prepare the nanophosphor.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic diagram illustrating a structure of an exemplary embodiment of a thin-film-type electroluminescent device;

FIG. 2A is an electron micrograph of a bulk phosphor used in Example 1;

FIG. 2B is an electron micrograph of a phosphor obtained after pulverization using a bead mill in Example 1;

FIG. 2C is an electron micrograph of a nanophosphor obtained after heat treatment of Example 1;

FIG. 3 is a graph of intensity (arbitrary units) versus scattering angle (degrees two theta) showing X-ray diffraction spectrum results of a nanophosphor prepared according to Example 1;

FIG. 4 is a graph of intensity (arbitrary units) versus wavelength (nanometers) showing photoluminescence spectra of a nanophosphor prepared according to Example 1 and a bulk phosphor prepared according to Comparative Example 1; and

FIG. 5 is a graph of brightness (candelas per square meter) versus driving voltage (Volts) showing electroluminescence spectra of electroluminescent devices manufactured according to Example 2 and Comparative Example 2.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects, features, and advantages of the present description. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups including at least one of the foregoing.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

The term “Group” as used herein, unless otherwise provided, refers to a Group of the periodic table of the elements.

A nanophosphor according to an embodiment, a light emitting device including the same, and a method of preparing the nanophosphor will now be disclosed in further detail.

A nanophosphor according to an embodiment includes ZnS, has an average particle diameter of about 10 to about 500 nanometers (nm), specifically about 20 to about 450 nm, more specifically about 40 to about 400 nm, and has a ZnS cubic (111) peak in an X-ray diffraction spectrum, wherein the ZnS cubic (111) peak has a full width at half maximum (“FWHM”) of equal to or less than about 0.280 degrees, specifically equal to or less than about 0.260 degrees, more specifically equal to or less than about 0.240 degrees.

For example, the average particle diameter of the nanophosphor may be about 100 to about 500 nm, specifically about 200 to about 400 nm.

The nanophosphor includes ZnS as the main constituent, and has a mixed structure comprising ZnS having cubic and hexagonal crystal structures. In the X-ray diffraction spectrum of the nanophosphor, a (001) peak of the cubic crystal structure of ZnS has a FWHM about 0.280 degrees (°) or less, specifically about 0.260° of less, more specifically about 0.240° or less, which is narrower than a FWHM of a bulk phosphor having an average particle diameter of equal to or greater than about 1 micrometer (μm). The narrower FWHM indicates that the nanophosphor is more highly crystalline than the bulk phosphor. For example, in the X-ray diffraction spectrum of the nanophosphor, the FWHM of the ZnS cubic (111) peak may be about 0.260 to about 0.280°, specifically about 0.265 to about 0.275°, more specifically about 0.270°.

The nanophosphor may further have a ZnS hexagonal (100) peak in the X-ray diffraction spectrum, in addition to the ZnS cubic (111) peak, and a ratio of the intensity of the ZnS hexagonal (100) peak to the intensity of the ZnS cubic (111) peak may be about 0.2 or greater, specifically about 0.5 or greater, more specifically about 0.1 or greater. When the ratio of the intensity of the ZnS hexagonal (100) peak to the intensity of the ZnS cubic (111) peak is within this range, the luminous efficiency of the nanophosphor may increase. For example, the ratio of the intensity of the ZnS hexagonal (100) peak to the intensity of the ZnS cubic (111) peak may be about 0.4 or greater, for example, about 0.4 to about 10, specifically about 0.5 to about 8, more specifically about 1 to about 6.

In the nanophosphor, the ZnS may be doped with Mn, a rare earth element, or a combination comprising at least one of the foregoing. For example, the nanophosphor may be a ZnS:Mn nanophosphor. For example, the nanophosphor may be at least one phosphor of ZnS:Mn; ZnS:Tb; ZnS:Sm; ZnS:Sm,F; ZnS:Sm,Cl; ZnS:Tm,F; or ZnS/SrS:Ce.

The nanophosphor may further include a sulfide-based phosphor (e.g., a sulfide). The sulfide-based phosphor may be a phosphor comprising at least one of a Group IIA element, a Group IIB element, or a Group VIA element, and may be doped with Mn, a rare earth element such as Tb or Sm, or a combination comprising at least one of the foregoing. For example, the nanophosphor may be a mixture of a ZnS:Mn phosphor and other phosphors. For example, the nanophosphor may be a mixture of a ZnS:Mn phosphor and at least one phosphor of ZnS:Sm, ZnS:Tb, BaAI₂S₃:Eu, SrS:Ce, CaS:Eu, CaS:Ce, ZnS:Sm,F, ZnS:Sm,Cl, ZnS:Tm,F, SrS:Ce,Eu ZnS/SrS:Ce, or CaGa₂S₄:Ce, or a combination comprising at least one of the foregoing.

The nanophosphor may have a luminance of equal to or greater than about 5 times the luminance of the bulk phosphor having an average particle diameter of equal to or greater than about 1 μm in a photoluminescence (“PL”) spectrum when exited by UV.

A light emitting device according to another embodiment includes the nanophosphor. The light emitting device may be a thin-film-type electroluminescent device, or other electroluminescent device such as a dispersion-type electroluminescent device, a hybrid electroluminescent device, or the like.

Unlike a commercially available thin-film-type electroluminescence device, the thin-film-type electroluminescence device including the nanophosphor can be provided without high temperature and high vacuum conditions when the thin film is formed, and thus a flexible substrate may be used, as in the dispersion-type electroluminescent device, and it is easy to manufacture the thin-film-type electroluminescence device. In addition, the thin-film-type electroluminescent device has a threshold voltage, and thus may be applied to a passive matrix (“PM”) driving-type display device. The nanophosphor may be photoluminescent, and thus may be used in various kinds of photoluminescent devices which emit light upon excitation by a separate excitation light source.

The light emitting device may further include another phosphor, and thus may be used as a white light emitting device which may emit white light. The white light emitting device may be used as a backlight of a traffic light, a communication device, or a display device, or may be used for illumination, but is not limited thereto. In an embodiment, the light emitting device may be used for any application where a white light emitting device may be used.

The thin-film-type electroluminescent device may further include at least one of a red phosphor, a blue phosphor, or a green phosphor, and thus may be used as a light emitting device which emits light having various colors.

The red phosphor may be at least one of ZnS:Sm,F; ZnS:Sm,Cl; CaS:Eu; or ZnS:Mn; but is not limited thereto. In an embodiment, the red phosphor may be any red phosphor which may be used in the thin-film-type electroluminescent device.

The blue phosphor may be at least one of BaAI₂S₃:Eu; ZnS:Tm,F; SrS:Ce; ZnS/SrS:Ce; or CaGa₂S₄:Ce; but is not limited thereto. In other words, the blue phosphor may be any blue phosphor which may be used in the thin-film-type electroluminescence device.

The green phosphor may be at least one of ZnS:Tb; ZnS:Tb,F; or CaS:Ce; but is not limited thereto. In other words, the green phosphor may be any green phosphor which may be used in the thin-film-type electroluminescent device.

In the light emitting device, the red phosphor may have an emission spectrum peak wavelength of about 600 to about 630 nm, the blue phosphor may have an emission spectrum peak wavelength of about 430 to about 470 nm, and the green phosphor may have an emission spectrum peak wavelength of about 510 to about 550 nm. For example, the ZnS:Mn nanophosphor may be combined with at least on of the red, blue, and green phosphors to manufacture a light emitting device which emit light of various colors.

The light emitting device may be a display device. The display device may be a passive matrix (“PM”) driving-type display device, but is not limited thereto. In other words, the light emitting device may be any kind of display device. For example, the display device may be a dot matrix type transparent display device including a plurality of pixels. Also, the display device may provide various colors such as red (R), green (G), and blue (B). The display device may be used in a television, a mobile phone, or the like, but is not limited thereto. Also, the display device may be used in any kind of device which may visually display a signal.

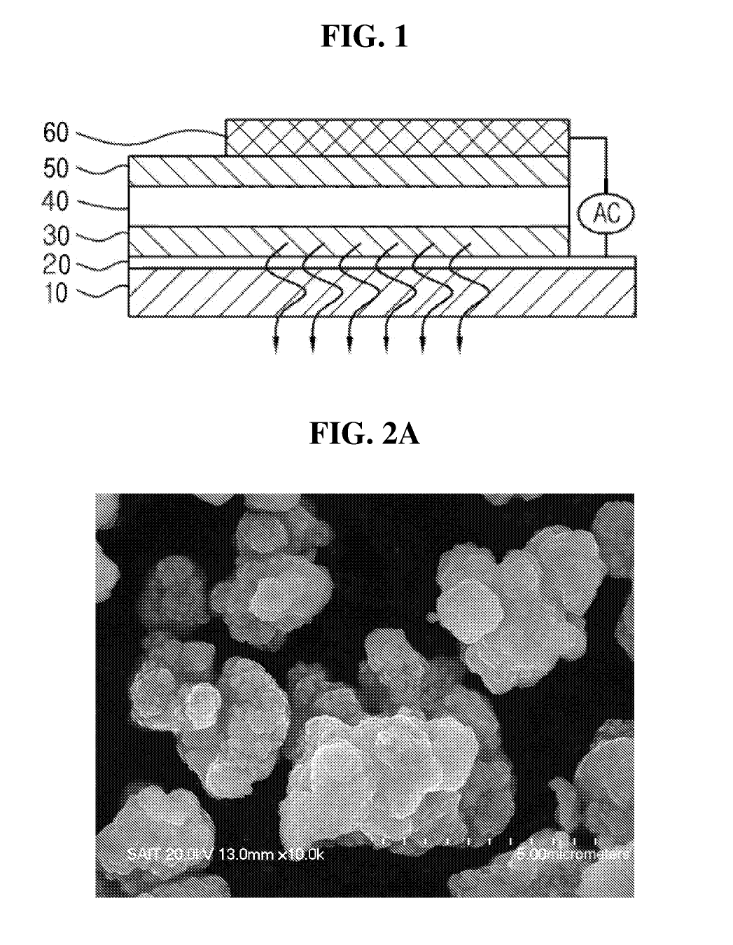

FIG. 1 is a schematic diagram illustrating a structure of an exemplary embodiment of an alternating-current thin-film-type electroluminescent device. Referring to FIG. 1, the electroluminescent device includes a substrate 10, a first electrode 20 disposed on the substrate 10, a first insulating layer 30 disposed on the first electrode 20, an emission layer 40 disposed on the first insulating layer 30, a second insulating layer 50 disposed on the emission layer 40, and a second electrode 60 disposed on the second insulating layer 50. When an alternating current (“AC”) is supplied between the second electrode 60 and the first electrode 20 to form an electric field, light generated by the phosphor contained in the emission layer 40 may be emitted to the outside via the first electrode 20. The first electrode 20 may be a transparent electrode. The second insulating layer 50 may be omitted if desired.

The thin-film-type electroluminescent device is not limited to the embodiment disclosed above, and may be any device having a structure in which a phosphor emits light by an electric field. For example, the thin-film-type electroluminescent device may further include a barrier layer for substantially preventing or effectively eliminating damage to the first and second insulating layers 30 and 50, respectively.

The substrate 10 is transparent, and may comprise any material suitable for use in a substrate. For example, the substrate 10 may comprise silica, glass, a polyethylene terephthalate (“PET”) film, or plastic, or a combination comprising at least one of the foregoing. A flexible material, such as a PET film, may be used to manufacture a flexible electroluminescent device.

The first electrode 20 may comprise a metal oxide, a conducting polymer, or a combination comprising at least one of the foregoing, and may comprise a nanostructured material, or a crystalline material, or a combination comprising at least one of the foregoing, but is not limited thereto. The first electrode 20 may be any electrode which may be used in the art.

Examples of the metal oxide include indium tin oxide (“ITO”), indium zinc oxide (“IZO”), InSnO, ZnO, SnO₂, NiO, or Cu₂SrO₂, or a combination comprising at least one of the foregoing.

An exemplary conducting polymer includes polydiphenylacetylene, poly(t-butyl)diphenylacetylene, poly(trifluoromethyl)diphenylacetylene, poly(bistrifluoromethyl)acetylene, polybis(t-butyldiphenyl)acetylene, poly(trimethylsilyl)diphenylacetylene, poly(carbazole)diphenylacetylene, polydiacetylene, polyphenylacetylene, polypyridineacetylene, polymethoxyphenylacetylene, polymethylphenylacetylene, poly(t-butyl)phenylacetylene, polynitrophenylacetylene, poly(trifluoromethyl)phenylacetylene, poly(trimethylsilyl)phenylacetylene, or derivatives thereof, or a combination comprising at least one of the foregoing. Also, the conducting polymer may include polyaniline, polythiophene, polypyrrole, polysilane, polystyrene, polyfuran, polyindole, polyazulene, polyphenylene, polypyridine, polybipyridine, polyphthalocyanine, polyphenylenevinylene, polyethylenedioxythiophene/polystyrenesulfonate (“PEDOT/PSS”), or derivatives thereof, or a combination comprising at least one of the foregoing.

The first insulating layer 30 and the second insulating layer 50 may each comprise a metal oxide having a resistivity of about 10⁵ ohms centimeters (“Ω·cm”), but are not limited thereto. The first and second insulating layers 30 and 50, respectively, may comprise any materials which may be used to form an insulating layer in the art. For example, Al₂O₃, BaTa₂O₆, BaTiO₃, SrTiO₃, Si₃N₄, AlN, SiO₂, TiO₂, Y₂O₃, Ta₂O₅, or Nb₂O₃, or a combination comprising at least one of the foregoing, may be used.

The emission layer 40 may include the nanophosphor. Also, the emission layer 40 may further include a sulfide-based phosphor (e.g., a sulfide) and/or an oxide-based phosphor (e.g., an oxide). In an embodiment, the nanophosphor may comprise at least one of a Group IIA element, a Group IIB element, or a Group VIA element, or a combination comprising at least one of the foregoing, and may be doped with Mn, a rare earth element, or a combination comprising at least one of the foregoing. For example, the nanophosphor may be a phosphor composed of a Group IIA element, a Group IIB element, and a Group VIA element, and may be doped with Mn or a rare earth element.

The second electrode 50 may comprise a metal or a conductive oxide, but is not limited thereto. In an embodiment, the second electrode 50 may comprise any conductive material. For example, nickel (Ni), platinum (Pt), gold (Au), silver (Ag), iridium (Ir), or aluminum (Al), or a combination comprising at least one of the foregoing may be used.

If the light emitting device includes a glass substrate, the first electrode 20 may be transparent, and the second electrode 60 may be non-transparent. If the light emitting device is transparent, the first and second electrodes 20 and 60 may be transparent.

The first electrode 20, the first insulating layer 30, the emission layer 40, the second insulating layer 50, and the second electrode 60 may be prepared using a commonly used method in the art without undue experimentation. For example, spin coating, printing, sputtering, or chemical vapor deposition (“CVD”) may be used.

The emission layer 40 may be prepared as follows. First, a nanophosphor and a resin are combined in a ratio of 1:99 to 99:1, specifically 1:90 to 90:1, more specifically 1:50 to 50:1 to prepare a nanophosphor paste. The nanophosphor paste is printed on a transparent electrode to obtain the emission layer 40.

For example, yellow, red, green, and blue nanophosphor pastes are prepared. The prepared yellow, red, green, and blue nanophosphor pastes are printed on a transparent electrode to be spaced apart from each other to obtain yellow, red, green, and blue emission layers.

Alternatively, the prepared yellow, red, green, and blue nanophosphor pastes are sequentially printed on a transparent electrode to obtain emission layers which emits various colors. Also, the prepared yellow, red, green, and blue nanophosphor pastes are combined together to prepare a mixed nanophosphor paste, and the mixed nanophosphor paste is printed on a transparent electrode to obtain at least one emission layer which emits various colors.

The thickness of the emission layer 40 may be about 0.01 to about 10000 micrometers (μm), specifically about 0.1 to about 1000 μm, more specifically 1 to about 100 μm, for example, about 0.1 to about 10 μm. The resin combined with the nanophosphor may be any resin used in the art. For example, a cyanoethyl pullulan resin may be used.

A method of preparing a nanophosphor includes: pulverizing a bulk phosphor having an average particle diameter (e.g., average largest particle diameter) of about 1 μm or more, specifically about 10 μm or more, more specifically about 100 μm or more; combining the pulverized bulk phosphor with a chlorine-based inorganic salt (e.g., a chloride) to form a mixture; and heat treating the mixture.

First, in the pulverizing process, the bulk phosphor is mechanically pulverized to prepare a pulverized nanophosphor having a nano-sized particle diameter.

The mechanical pulverization may be performed using a bead mill, but is not limited thereto. In an embodiment, any kind of pulverization method used in the art may be used. The pulverization conditions of the bead mill are not particularly limited, and may be determined without undue experimentation. The pulverizing may be performed using as a grinding aid a solvent such as ethanol. The solvent may be removed by centrifugal separation after the pulverizing process.

For example, the pulverizing of the bulk phosphor may be performed in such a way that about 110 milliliters (“ml”) of spherical ZrO₂ beads having a diameter (e.g., average largest diameter) of about 0.1 millimeters (“mm”) are added to a bead mill having a mill volume of 150 ml, a bulk phosphor and ethanol are added to the bead mill, wherein the amount of ethanol added is about 100 to about 3000 parts by weight, specifically about 200 to about 2500 parts by weight, more specifically about 300 to about 2000 parts by weight, based on 100 parts by weight of the bulk phosphor, and the resulting mixture is then stirred at a mill frequency of about 10 to about 100 hertz (Hz), specifically about 20 to about 80 Hz, more specifically about 50 Hz, at a rate of about 100 to about 500 revolutions per minute (“rpm”), specifically about 200 to about 400 rpm, more specifically about 300 rpm, for about 1 to about 5 hours, specifically about 2 to about 4 hours, more specifically about 3 hours.

The pulverized bulk phosphor may have an average particle diameter (e.g. average largest particle diameter) of equal to or less than about 100 nm, specifically about 1 to about 90 nm, more specifically about 2 to about 80 nm.

The bulk phosphor may comprise at least one of a sulfide-based phosphor and an oxide-based phosphor. The at least one of the sulfide-based phosphor and the oxide-based phosphor is not particularly limited, and may be any phosphor used in the art. In an embodiment, the sulfide- or oxide-based phosphor may be a phosphor comprising a sulfide- or oxide-based crystalline parent material doped with an activator and/or a co-activator as an emission center. For example, the sulfide- or oxide-based phosphor may be a phosphor composed of a sulfide- or oxide-based crystalline parent material doped with an activator and/or a co-activator as an emission center. In an embodiment, the sulfide-based phosphor and the oxide-based phosphor may comprise a phosphor comprising a Group IIA element, a Group IIB element, and a Group VIA element, and the phosphor may be doped with Mn, a rare earth element such as Tb or Sm, or a combination comprising at least one of the foregoing. For example, the sulfide-based phosphor and the oxide-based phosphor may be a phosphor composed of a compound comprising a Group IIA element, a Group IIB element, and a Group VIA element, wherein the phosphor is doped with Mn, a rare earth element such as Tb or Sm, or a combination comprising at least one of the foregoing. For example, the bulk phosphor may be ZnS:Mn; ZnS:Tb; or ZnS:Sm; or a combination comprising at least one of the foregoing. The bulk phosphor may also be at least one of ZnS:Mn; ZnS:Tb; ZnS:Sm; BaAI₂S₃:Eu; SrS:Ce; CaS:Eu; CaS:Ce; ZnS:Sm,F; ZnS:Sm,Cl; ZnS:Tm,F; SrS:Ce,Eu; ZnS/SrS:Ce; or CaGa₂S₄:Ce.

Next, the pulverized bulk phosphor particles are combined with a chlorine-based inorganic salt to provide a mixture. The bulk phosphor particles may be fully or partially coated with the chlorine-based inorganic salt in the mixture.

The amount of the bulk phosphor may be about 20 to about 60 parts by weight, specifically about 30 to about 50 parts by weight, more specifically about 40 parts by weight, based on 100 parts by weight of the mixture of the bulk phosphor and the chlorine-based inorganic salt. When the amount of the bulk phosphor is within this range, a nanophosphor with enhanced luminance may be provided.

The chlorine-based inorganic salt may be at least one of NaCl, KCl, RbCl, CsCl, or MgCl₂, or a combination comprising at least one of the foregoing. The chlorine-based inorganic salt may be included in a flux. The flux of the chlorine-based inorganic salt comprises an aqueous suspension or solution in which the chlorine-based inorganic salt is suspended or dissolved in a high concentration. For example, the concentration of NaCl in a NaCl flux may be about 10 to about 90 weight percent (“wt %”), specifically about 40 to 50 wt %, more specifically about 42 wt %, but is not limited thereto. In an embodiment, the concentration of the chlorine-based inorganic salt in the flux may be appropriately selected.

The combining of the pulverized bulk phosphor with the chlorine-based inorganic salt may be performed by adding the pulverized bulk phosphor to the flux of the chlorine-based inorganic salt and dispersing the pulverized bulk phosphor therein. The pulverized bulk phosphor particles may be dispersed in the aqueous solution in which the chlorine-based inorganic salt is dissolved. As a result, the surface of the bulk phosphor particles may be partially or fully coated with the chlorine-based inorganic salt. For example, the flux of the chlorine-based inorganic salt may be a NaCl flux.

Next, the mixture, i.e., the bulk phosphor particles coated with the chlorine-based inorganic salt, is heat treated to provide a nanophosphor having an average particle diameter (e.g. average largest particle diameter) of about 10 to about 500 nm, specifically 20 to about 450 nm, more specifically 30 to about 400 nm.

The heat treatment may be performed at a temperature of about 500 to about 1200° C., specifically about 600 to about 1100° C., more specifically about 700 to about 1000° C., in a substantially inert atmosphere for about 10 to about 300 minutes, specifically about 20 to about 250 minutes, more specifically about 30 to about 200 minutes. For example, the heat treatment may be performed at a temperature of about 700 to about 800° C., specifically about 710 to about 790° C., more specifically about 720 to about 780° C. The substantially inert atmosphere may be a nitrogen atmosphere. When the heat treatment temperature is within this range, the pulverized bulk phosphor particles are grown, and the crystallinity of the particles increases. The nanophosphor may have an average particle diameter (e.g., average largest particle diameter) of about 100 to about 500 nm, specifically about 150 to about 450 nm, more specifically about 200 to about 400 nm. If the chlorine-based inorganic salt is a solid (e.g., dry) powder, a relatively high heat treatment temperature may be desirable. On the other hand, if the chlorine-based inorganic salt is in a flux, a lower heat treatment temperature may be desirable.

The method of preparing a nanophosphor may further include drying the mixture of the pulverized bulk phosphor and the chlorine-based inorganic salt before the heat treatment. The drying process may be performed at a temperature of about 50 to about 120° C., specifically about 60 to about 110° C., more specifically about 70 to about 100° C. for about 10 to about 300 minutes, specifically about 20 to about 250 minutes, more specifically about 40 to about 200 minutes. The solvent may be removed by the drying process, and the pulverized bulk phosphor particles coated with the chlorine-based inorganic salt may be obtained.

The method of preparing a nanophosphor may further include removing the chlorine-based inorganic salt after the heat treatment. For example, a mixture of a nanophosphor and the chlorine-based inorganic salt, obtained after the heat treatment, may be suspended or dissolved in water, and the mixture (e.g., solution) filtered to separate out the nanophosphor.

An embodiment will be further disclosed in more detail with reference to the following examples. However, these examples shall not limit the scope of the disclosed embodiments.

### Preparation of Nanophosphor

### Example 1

A 110 ml quantity of spherical ZrO₂ beads having a diameter of 0.1 mm, 50 g of a ZnS:Mn bulk phosphor having an average particle diameter in the range of 3 to 5 μm, and 450 grams (g) of ethanol were added to a bead mill having a mill volume of 150 ml (Ultra Apex mill manufactured by KOTOBUKI), and the mixture was pulverized at a mill frequency of 35 Hz and a flow rate of 130 rpm for 160 minutes.

The pulverized mixture was put in a centrifugal separator, and was rotated at 8000 rpm for 20 minutes to remove ethanol.

A 20 g quantity of the pulverized bulk phosphor was added to an aqueous NaCl solution in which 27.6 g of NaCl was dissolved to prepare an aqueous NaCl solution in which the amount of the pulverized bulk phosphor in a mixture of the pulverized bulk phosphor and NaCl was 42 wt %. Subsequently, the aqueous NaCl solution was stirred with ultrasonic waves for 1 hour. Then, the aqueous NaCl solution in which the pulverized bulk phosphor was dispersed was dried at 95° C. for 4 hours or more to remove water. The mixture of the pulverized bulk phosphor and NaCl without water was heat treated at 700° C. in a nitrogen atmosphere for 30 minutes. After the heat treatment, the mixture was dissolved in water, and the mixed solution was filtered using a filter paper to separate out the nanophosphor. The obtained nanophosphor had an average particle diameter of 300 nm.

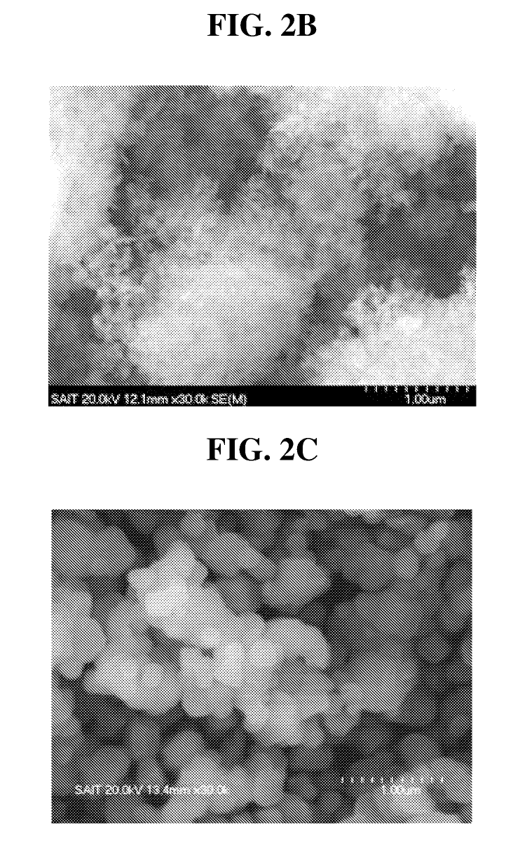

The electron micrographs of the bulk phosphor used in Example 1, the pulverized bulk phosphor, and the finally obtained nanophosphor are respectively shown in FIGS. 2A through 2C.

### Comparative Example 1

The bulk phosphor used in Example 1 was used.

### Manufacture of Thin-Film-Type Electroluminescence Device

### Example 2

Indium tin oxide (“ITO”) was coated on a glass substrate (soda lime glass) having a thickness of 1.8 mm by sputtering to form a first electrode having a thickness of 1500 Å. Then, 5 g of a BaTiO₃ nanodielectric having a size of 300 nm and 5 g of cyanoresin (shin-Etsu chemical Co., Ltd. CR-M grades of polymer type) was mixed on the first electrode by using a softener, and the mixture was spin coated at 1000 rpm to form an insulating layer having a thickness of 1000 nm. Then, the resulting structure was dried in a microwave oven at 130° C. for 30 minutes. A 5 g quantity of the nanophosphor prepared according to Example 1 and 5 g of cyanoresin (shin-Etsu chemical Co., Ltd. CR-M grades of polymer type) were mixed on the insulating layer by using a softener, and the mixture was then spin coated at 1000 rpm to form an emission layer having a thickness of 1000 nm. Then, the resulting structure was dried in a microwave oven at 130° C. for 30 minutes. Subsequently, Al was sputtered on the emission layer to form a second electrode having a thickness of 1500 Å, thereby completing the manufacture of the thin-film-type electroluminescence device.

### Comparative Example 2

A thin-film-type electroluminescence device was manufactured in the same manner as in Example 2, except that the bulk phosphor of Comparative Example 1 was used instead of the nanophosphor of Example 1.

### Evaluation Example

### X-Ray Diffraction Spectrum Test

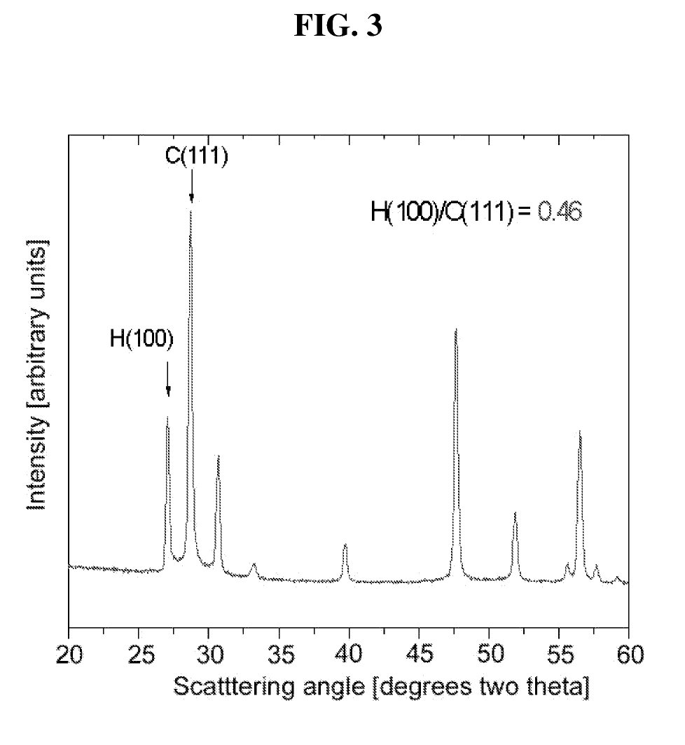

An X-ray diffraction spectrum of the nanophosphor of Example 1 was measured, and the results are shown in FIG. 3.

As shown in FIG. 3, a ZnS cubic (111) peak and a ZnS hexagonal (100) peak were present in the X-ray diffraction spectrum. The ZnS cubic (111) peak had a full width at half maximum (“FWHM”) of 0.268 degrees (°). In addition, a ratio of the intensity of the ZnS hexagonal (100) peak to the intensity of the ZnS cubic (111) peak was 0.46.

Although not illustrated in FIG. 3, a ZnS cubic (111) peak of the bulk phosphor of Comparative Example 1 had a FWHM of 0.286°. In addition, a ratio of the intensity of the ZnS hexagonal (100) peak to the intensity of the ZnS cubic (111) peak was less than 0.2.

Therefore, it was confirmed that the nanophosphor of Example 1 was more highly crystalline than the bulk phosphor of Comparative Example 1.

### Evaluation Example 2

### Photoluminescence (PL) Spectrum Test

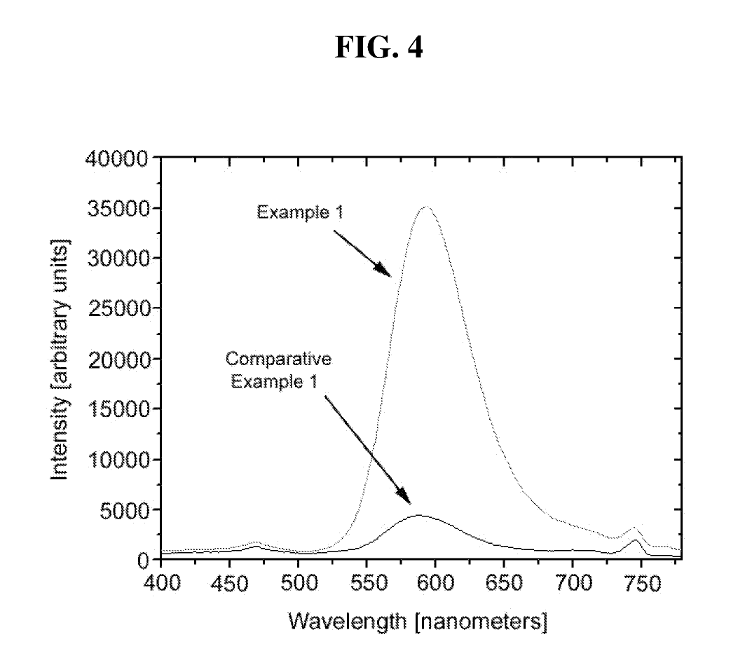

A photoluminescence spectrum was performed on the nanophosphor of Example 1 and the bulk phosphor of Comparative Example 1. Monochromic ultraviolet rays having a wavelength of 245 nm were used as excitation light. The PL spectrum test was performed using a luminance colorimeter (TOPCON, BM-7). The test results are shown in FIG. 4.

As shown in FIG. 4, the nanophosphor of Example 1 had a luminance about 5 times greater than that of the bulk phosphor of Comparative Example 1.

### Evaluation Example 3

### Electroluminescence (EL) Spectrum Test

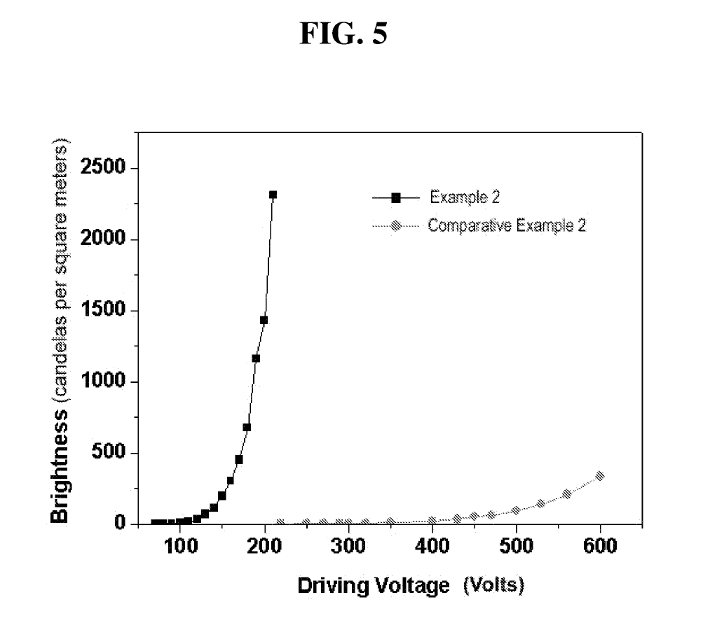

An electroluminescence (EL) spectrum was performed the electroluminescence devices of Example 2 and Comparative Example 2. The EL spectrum test was performed using a luminance colorimeter (TOPCON, BM-7). The test results are shown in FIG. 5.

As shown in FIG. 5, the electroluminescence device of Example 2 including the nanophosphor exhibited a distinct threshold voltage, and had significantly enhanced luminance compared with the electroluminescence device of Comparative Example 2 including the bulk phosphor.

The electroluminescence device of Example 2 exhibited a luminance of 2300 candelas per square meter (cd/m²) at 210 volts (V), and the electroluminescence device of Comparative Example 2 exhibited a luminance of 1 cd/m² at 220 V.

As described above, according to an embodiment, a nanophosphor is highly crystalline and may be mass produced in a simplified process, and the prepared nanophosphor may have significantly enhanced luminance.

It shall be understood that the embodiments disclosed herein shall be considered in a descriptive sense only and not for purposes of limitation. Descriptions of features or aspects within each embodiment should be considered as available for other similar features or aspects in other embodiments.

What is claimed is:

1. A nanophosphor comprising,
ZnS, having an average particle diameter of about 10 to about 500 nanometers and having a ZnS cubic (111) peak in an X-ray diffraction spectrum, wherein the ZnS cubic (111) peak has a full width at half maximum of about 0.280 degrees or less.

2. The nanophosphor of claim 1, wherein the ZnS cubic (111) peak has a full width at half maximum of about 0.260 to about 0.280 degrees.

3. The nanophosphor of claim 1, further exhibiting a ZnS hexagonal (100) peak in X-ray diffraction spectrum, wherein a ratio of the intensity of the ZnS hexagonal (100) peak to the intensity of the ZnS cubic (111) peak is about 0.2 or greater.

4. The nanophosphor of claim 1, further exhibiting a ZnS hexagonal (100) peak in X-ray diffraction spectrum, wherein a ratio of the intensity of the ZnS hexagonal (100) peak to the intensity of the ZnS cubic (111) peak is about 0.4 or greater.

5. The nanophosphor of claim 1, wherein the ZnS is doped with Mn, a rare earth element, or a combination comprising at least one of the foregoing.

6. The nanophosphor of claim 1, comprising ZnS:Mn; ZnS:Sm; ZnS:Tb; ZnS:Sm,F; ZnS:Sm,Cl; ZnS:Tm,F; or ZnS/SrS:Ce; or a combination comprising at least one of the foregoing.

7. A light emitting device comprising the nanophosphor of claim 1.

8. The light emitting device of claim 7, comprising a thin-film-type electroluminescence device.

9. The light emitting device of claim 7, further comprising a red phosphor, a blue phosphor, or a green phosphor, or a combination comprising at least one of the foregoing.

10. A display device comprising the light emitting device of claim 7.

11. A method of preparing a nanophosphor, the method comprising:
pulverizing a bulk phosphor having an average particle diameter of about 1 micrometer or greater;
combining the pulverized bulk phosphor with a chlorine-based inorganic salt to provide a mixture; and
heat treating the mixture to prepare the nanophosphor.

12. The method of claim 11, wherein the bulk phosphor is a sulfide-based phosphor.

13. The method of claim 11, wherein the bulk phosphor comprises ZnS:Mn; ZnS:Tb; ZnS:Sm; ZnS:Sm,F; ZnS:Sm,Cl; ZnS:Tm,F; or ZnS/SrS:Ce; or a combination comprising at least one of the foregoing.

14. The method of claim 11, wherein the chlorine-based inorganic salt comprises at least one of NaCl, KCl, RbCl, CsCl, or MgCl₂, or a combination comprising at least one of the foregoing.

15. The method of claim 11, wherein the amount of the bulk phosphor is about 20 to about 60 parts by weight, based on 100 parts by weight of the mixture of the bulk phosphor and the chlorine-based inorganic salt.

16. The method of claim 11, wherein the combining of the pulverized bulk phosphor and the chlorine-based inorganic salt comprises
adding the pulverized bulk phosphor to a flux comprising the chlorine-based inorganic salt, and
dispersing the pulverized bulk phosphor therein.

17. The method of claim 11, wherein the heat treating is performed at a temperature of about 500 to about 1200° C. in a substantially inert atmosphere for about 10 to about 300 minutes.

18. The method of claim 11, further comprising, before the heat treating, drying the mixture of the pulverized bulk phosphor and the chlorine-based inorganic salt.

19. The method of claim 11, further comprising, after the heat treating, removing the chlorine-based inorganic salt.
